(19) United States
(12) Patent Application Publication
(10) Pub. No.: US 2014/0091532 A1
(43) Pub. Date: Apr. 3, 2014

(54) Plug-In Piece

(71) Applicant: Carl Freudenberg KG, Weinheim (DE)

(72) Inventors: Hans UNGER, Abtsteinach (DE); Ralf HELDMANN, Wald-Michelbach (DE); Ingo STEPHAN, Rimbach (DE); Markus CLEMENS, Reichelsheim (DE); Carsten HARTMANN, Hirschberg (DE); Ernst JAKOB, Rimbach (DE); Stephan REDDIG, Kaiserslautern (DE)

(73) Assignee: CARL FREUDENBERG KG, Weinheim (DE)

(21) Appl. No.: 13/974,815

(22) Filed: Aug. 23, 2013

(30) Foreign Application Priority Data
Sep. 28, 2012 (DE) 10 2012 019 105.7

(51) Int. Cl. F16L 17/025

(52) U.S. Cl. CPC F16L 17/025
USPC 277/616

(57) ABSTRACT

A plug-in piece for sealing connection of two mutually assigned cylindrical surfaces includes an essentially tubular support body which on its ends exhibits annularly encircling sealing elements with a spherically curved sealing surface with a fluting formed therein.

### CROSS-REFERENCE TO RELATED APPLICATIONS

This application claims the benefit and priority of German Application No. 10 2012 019 105.7, filed Sep. 28, 2012. The entire disclosure of the above application is incorporated herein by reference.

### FIELD

The present disclosure relates to a plug-in piece for the sealing connection of two mutually assigned cylindrical surfaces, comprising a support body which is substantially in the shape of a hollow body and has at least one annularly encircling sealing element which can be brought into engagement with one of the cylindrical surfaces to be sealed in order to produce a tight connection, wherein the sealing element is designed as a sealing bead which annularly encircles the outer surface of the support body and has a curved sealing surface.

### BACKGROUND

Plug-in pieces are generally used to connect in a media-impermeable manner two mutually assigned housing parts, such as for example, an engine block with auxiliaries. They generally include of a support body in the shape of a tubular or hollow body made of a semi-rigid material, both ends of which are provided on their outside and/or inside circumference with annularly encircling sealing elements made of a rubber-elastic material. To connect the two housing parts, the ends of the plug-in pieces are inserted in corresponding holes in the housing parts, or plugged into corresponding pipe sockets.

Upon insertion of the ends of the hollow body-like support body into the respective holes of the housing parts or a pipe socket into the plug-in piece, the sealing elements made of the rubber-elastic material form a tight seal with the inside walls of the holes or the outside walls of the pipe socket, thereby producing a media-impermeable connection between the two housing parts.

A plug-in piece of the aforementioned kind is known for example from EP 1 024 322 A2. Each of the two ends of the known plug-in piece has a sealing bead with a curved surface. The curved sealing bead ensures a secure tight fit with the inside surface of the hole, even when the longitudinal axes of the holes and of the plug-in piece are angularly offset relative to one another. The disadvantage of the known plug-in piece is that, depending on the outward radial extension of the sealing bead, relatively high insertion forces are required when installing the plug-in piece.

### SUMMARY

The object of the present disclosure consists in further developing a plug-in piece of the aforementioned kind so that it is easier to install, that is, it requires less insertion force, and without loss of tightness.

The plug-in piece according to the present disclosure for the sealing connection of two mutually assigned cylindrical surfaces comprises a support body which is substantially in the shape of a hollow body and has at least one annularly encircling sealing element which can be brought into engagement with one of the cylindrical surfaces to be sealed in order to produce a tight connection, wherein the sealing element is designed as a sealing bead that annularly encircles the outer surface of the support body and has a curved sealing surface. According to the present disclosure, the annularly encircling sealing bead has in the region of its curved sealing surface an encircling fluting following the contour thereof.

It has been found that a fluting on the curved surface of the sealing bead following the contour thereof leads to a reduction in the axial installation forces when pressing the plug-in piece into a cylindrically shaped hollow body, or into a hole. This results, even though it is to be expected that the pressing forces acting on the elevations of the sealing bead via the inside wall of the hollow body or hole are greater than is the case with a non-fluted bead.

According to the present disclosure, the flutes are integrated in the region of the sealing surface of the sealing bead. The sealing surface of the sealing bead comprises within the meaning of the present disclosure the maximum possible surface contact of the sealing bead with the cylindrical surface to be sealed. In particular, it also comprises the surface areas that can come into contact with the cylindrical surfaces when, as the bead is rolled, the plug-in piece and the cylindrical surface to be sealed are angularly offset relative to one another.

The geometrical shape of the flutes can be freely chosen within a broad range. In principal, it is the case, however, that numerous small and flat flutes result in installation forces that approximate those of a smooth sealing bead. Thus, for example, installation forces in conjunction with a lamellar fluted structure in which the sealing bead has a contour in the shape of an orthogonal meander in longitudinal section, are substantially greater than is the case with a rounded contour.

The lowest installation forces are achieved when the flutes are shaped such that the sealing bead has a wavy outer contour in longitudinal section.

The height, width and distance between flutes to be selected depend on the size of the diameter of the plug-in piece and on the given installation setting. The person skilled in the art is capable without needing inventive skill to arrive at suitable dimensions.

Taking into consideration the above indicated preferred ranges for the width and distance of the flutes to one another, a plug-in piece according to the present disclosure has preferably 2 to 6 flutes, more preferably 2 to 4 flutes. However, the effect according to the present disclosure occurs even if there is just one flute. Thus, “fluting” within the meaning of the present disclosure comprises both a single flute encircling the sealing bead in a plane perpendicular to the symmetrical axis, and multiple such flutes spaced axially apart from each other.

According to a further preferred embodiment of the present disclosure, the sealing bead is spherically shaped. The advantage of this is that in the event the plug-in piece and the cylindrical surface to be sealed are angularly offset relative to one another, the sealing bead is able to roll on the cylindrical surface.

It is especially preferred in this case if the spherical radius of the sealing bead is selected such that the center point of the sphere lies approximately on the axis of symmetry of the support body. In such case, the pressing forces in the installation space are largely constant over the entire surface of the sealing bead, regardless of the angle of positioning.

Preferably, the deviation of the center point of the sphere from the axis of symmetry is less than 10% of the radius of the sphere, that is, the outside diameter of the sealing bead. In extreme angles of positioning, variable pressing forces may occur with deviations of greater than 10%. A deviation of only approximately 2% of the radius of the sphere is especially preferred. A deviation of less than 2% is difficult to achieve, due to manufacturing tolerances which in the case of conventional plug-in piece geometries allow a determination of the center point to be made in the tool with only an error of from 0.5% to 1% of the outside diameter.

According to a further preferred embodiment of the present disclosure, the support body has a second sealing bead encircling the outer circumference of said support body. This plug-in piece is adapted to sealingly connect two mutually assigned holes with one another. The two sealing beads are in general arranged at the two end regions of the support body.

Preferably, such plug-in pieces for connecting hollow bodies or holes of identical inside diameter are in the shape of a dumb-bell, wherein the first sealing bead and the second sealing bead are of mirror-inverted design with respect to each other at the two ends.

The plug-in piece according to the present disclosure can also perform an adapter function in the case of cylindrical surfaces to be connected that have different inside and outside diameters, in that the inside diameter of the support body expands from one end face to the other end face. In this case, the transition from the smaller to the larger diameter may be in stepwise or continuous.

However, the plug-in piece can also be designed to include at one end an outer encircling sealing bead designed according to the present disclosure and to be adapted at the other end for sealing with respect to an outer cylindrical surface, for example, the outer surface of a tubular shaped hollow body that can be inserted in said second end. For this purpose, instead of an outer encircling sealing element, it is possible to provide a further radially inwardly pointing, second sealing element at the second end of the support body. In narrow installation spaces, it is advantageous if the first and the second sealing element lie in the same axial plane. The advantage of this is that the plug-in piece as a connecting element uses no additional installation space, since the tubular shaped hollow bodies can be slipped over each other.

A plug-in piece according to the present disclosure can also include dust lips to prevent dust from penetrating.

Likewise, centering lips or centering cams known per se can also be provided to aid in centering the plug-in piece in the hole.

To strengthen the hold within a hole, retention lips can be provided which, when extracted, become wedged in the hole.

According to a still further embodiment of the present disclosure, the outer and/or inner circumference of the support body is at least partially provided with a casing. The latter protects the hollow body against mechanical as well as chemical stresses which could impact it from the outside. In particular, casings can protect against corrosion in the case of hollow bodies made of metal, thereby avoiding secondary rust prevention measures, such as for example, the application of lacquers or the like.

Preferably, the sealing elements and the casing are formed as a single piece which merge into one another.

According to a still further embodiment of the present disclosure, the sealing elements include beveled insertion surfaces to further facilitate installation. The sealing elements can also jut out somewhat at the end faces of the hollow body.

The cylindrically shaped hollow body consists preferably of an impact-resistant material, especially preferably of a metallic material. This ensures dimensional stability of the hollow body and in particular of the through holes.

The sealing elements and the casing consist preferably of a rubber-elastic material, especially preferably of an elastomer or PTFE. In the case of an elastomeric material, the sealing beads and the casing are preferably vulcanized onto the support sleeve. In this way, an absolute impermeable bond is formed between the elastomer and the connecting sleeve.

The plug-in-piece is described in greater detail below with reference to the drawings.

### DRAWINGS

In the drawings:

FIGS. 1A and 1B are a schematic longitudinal sectional view and a perspective 3D view, respectively, of a plug-in piece according to the present disclosure with plug-in pieces at both end faces, the sealing surface of which includes wavy fluting;

FIGS. 2A and 2B are views similar to the plug-in piece having FIGS. 1A and 1B, respectively, with the plug-in piece having a lamellar fluting;

FIG. 3 is a schematic longitudinal sectional view of a plug-in piece according to the present disclosure with spherically-shaped sealing beads at both end faces, the center point of the sphere of which lies on the symmetrical axis of the support element and the sealing surface of which includes a wavy fluting;

FIG. 4 shows the plug-in piece of FIG. 3 with a lamellar fluting;

FIGS. 5A and 5B are a schematic longitudinal sectional view and a 3D view, respectively, of a plug-in piece according to the present disclosure with a sealing bead at one end face and an inwardly pointing sealing element at the other end face, both of which lie in a radial plane, wherein the sealing surface of the sealing bead includes a wavy fluting;

FIGS. 6A and 6B show the plug-in piece of FIGS. 5A and 5B, with a lamellar fluting;

FIGS. 7A and 7B are a schematic longitudinal sectional view and a 3D view, respectively, of a plug-in piece according to the present disclosure with a spherically-shaped sealing bead that includes wavy fluting at one end face, wherein the center point of the sphere lies on the symmetrical axis of the support element, and an inwardly point sealing element at the other end face, wherein both sealing elements lie in a radial plane;

FIGS. 8A and 8B show the plug-in piece of FIGS. 7A and 7B with a lamellar fluting;

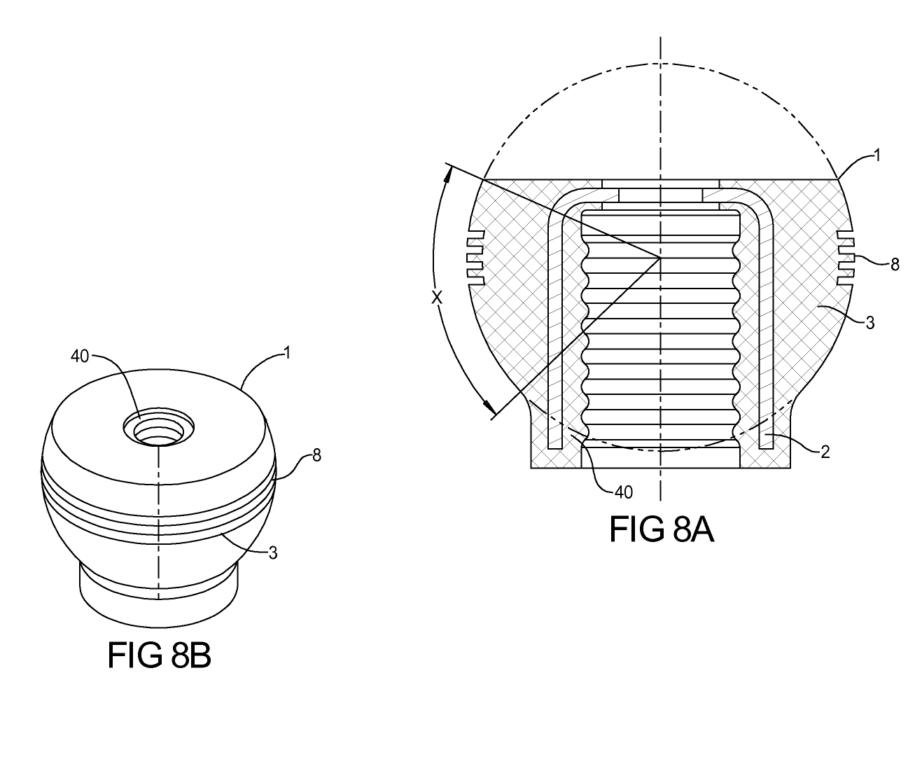

FIG. 9 shows the plug-in piece of FIG. 3 with adapter function;

FIGS. 10A and 10B are a schematic longitudinal sectional view and a 3D view, respectively, of the plug-in piece of FIG. 3 with centering cams;

FIG. 11 shows the plug-in piece of FIG. 3 with dust lips;

FIGS. 12A and 12B are a schematic longitudinal sectional view and a 3D view, respectively, that show the plug-in piece of FIG. 5 with dust lips;

FIGS. 13A and 13B are a schematic longitudinal sectional view and a 3D view, respectively, that show the plug-in piece of FIG. 5 with centering cams.

### DETAILED DESCRIPTION

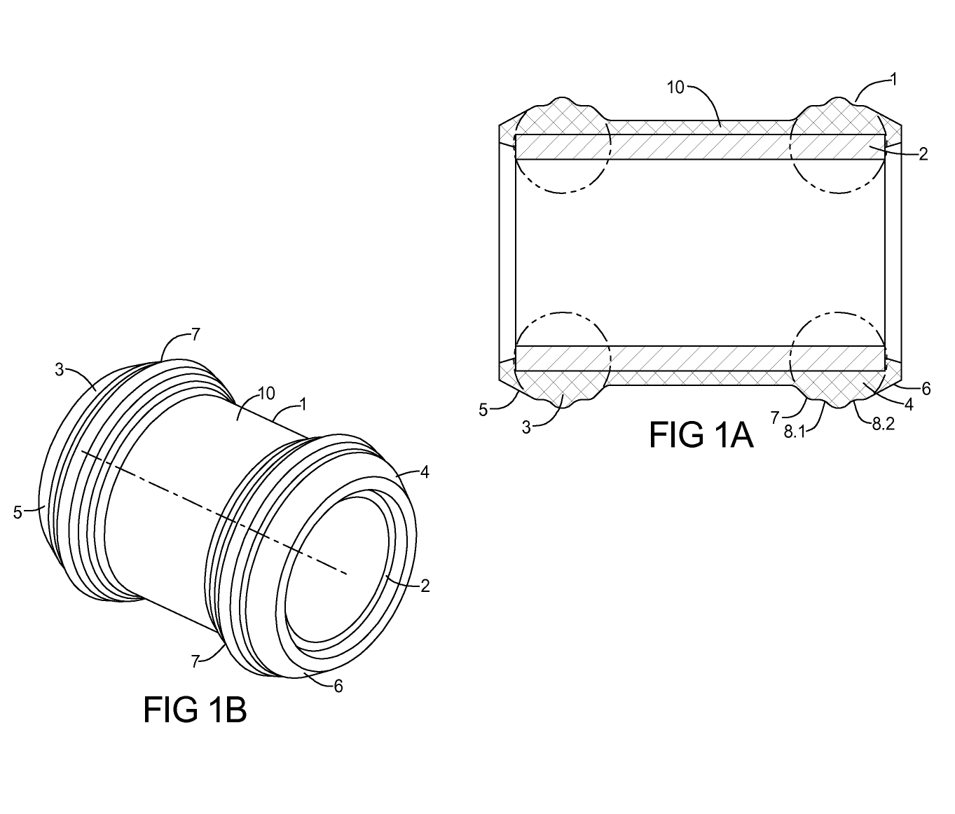

Seen in FIGS. 1A and 1B 1 is an exemplary embodiment of a plug-in piece 1 having a support body 2, the outer circumference of which is encircled by sealing beads 3 and 4 at both ends. The sealing beads 3 and 4 are of mirror-inverted design with respect to one another, which lends the plug-in piece 1 the shape of a dumb-bell. The sealing beads 3 and 4 include, without limitation to generality in the embodiment shown, beveled insertion surfaces 5 and 6 intended to facilitate installation. In addition, the sealing beads 3 and 4 jut out axially somewhat at both ends.

The sealing beads 3 and 4 in the figure are partially spherically shaped in cross-section. For purposes of illustration, the radius of the sphere is drawn in as a dot-and-dashed line. On the curved surface that forms the sealing surface, the sealing beads 3 and 4 according to the present disclosure are provided in the region of the sealing surface with a wavy fluting 7 in longitudinal section. In the embodiment shown, the fluting comprises two flutes 8.1, 8.2 respectively (for reasons of clarity and given the symmetry of the sealing beads, only one sealing bead is shown in this and the following figures with the corresponding reference numerals).

Identical parts are indicated in the figures by identical reference numerals.

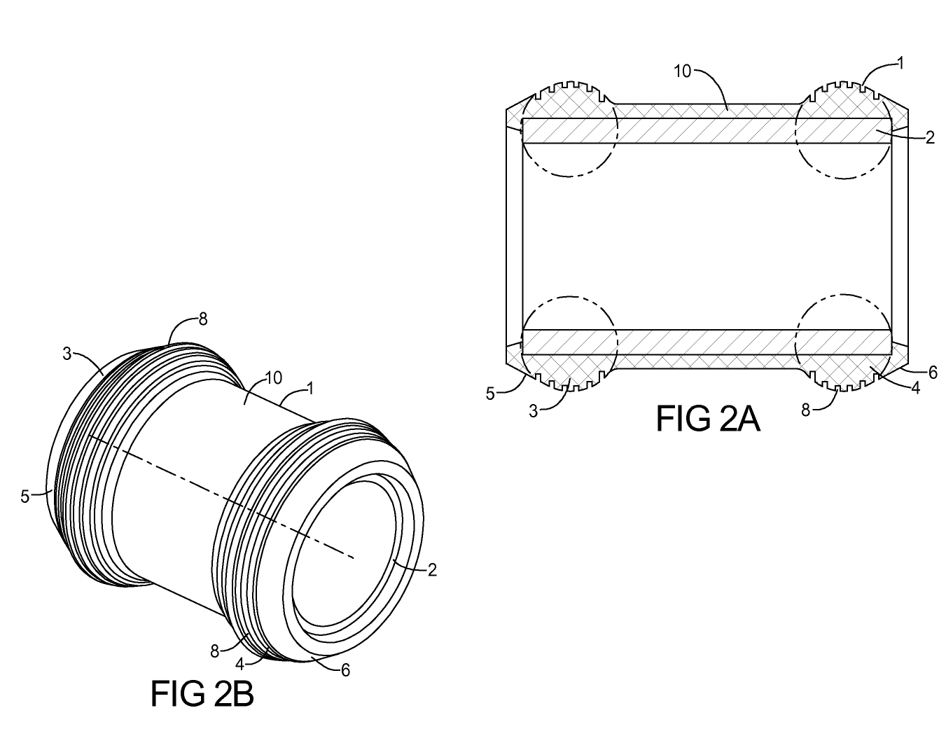

FIGS. 2A and 2B show a further exemplary embodiment of a plug-in piece according to the present disclosure. In the plug-in piece 1 shown, the fluting is formed by a lamellar structure 8, in which the sealing beads 3, 4 have an orthogonal, meander-like contour in longitudinal section in the region of the sealing surface.

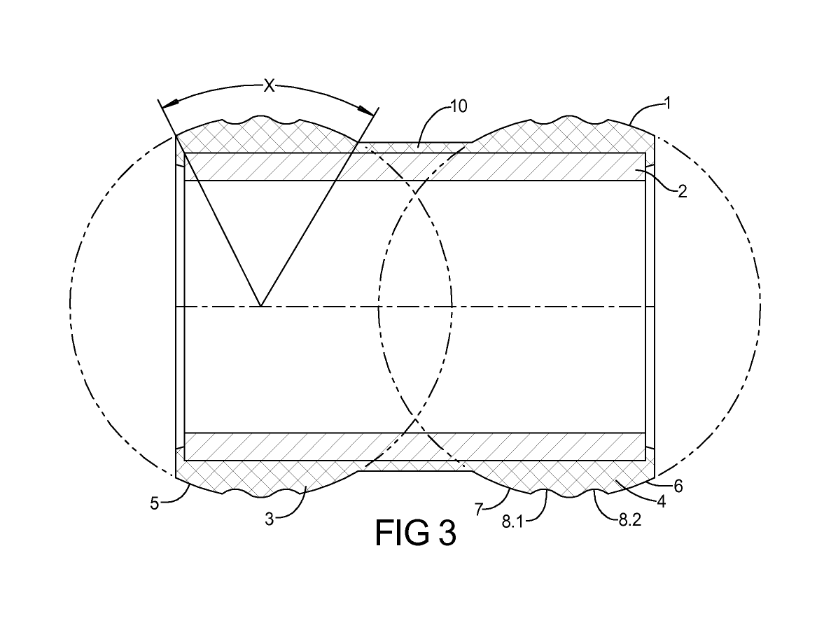

FIG. 3 shows an exemplary embodiment in which the spherical radius of the sealing beads 3, 4 is selected such that, as is clearly seen by the radii indicated by dot-and-dashed lines, the center point of the sphere lies approximately on the symmetrical axis of the support body. In this case, the pressing forces are constant over the entire surface of the sealing beads, regardless of the angle of positioning. In this figure, as in the remaining figures, the outer circumference of the plug-in piece 1 is also surrounded by a casing 10 which, without limitation to generality, is formed together with the sealing elements 3, 4 as a single piece and from the same material.

In longitudinal section the spherically shaped sealing bead is represented as a circular segment with the center angle “X”. The exemplary embodiment represented shows a wavy fluting 7.

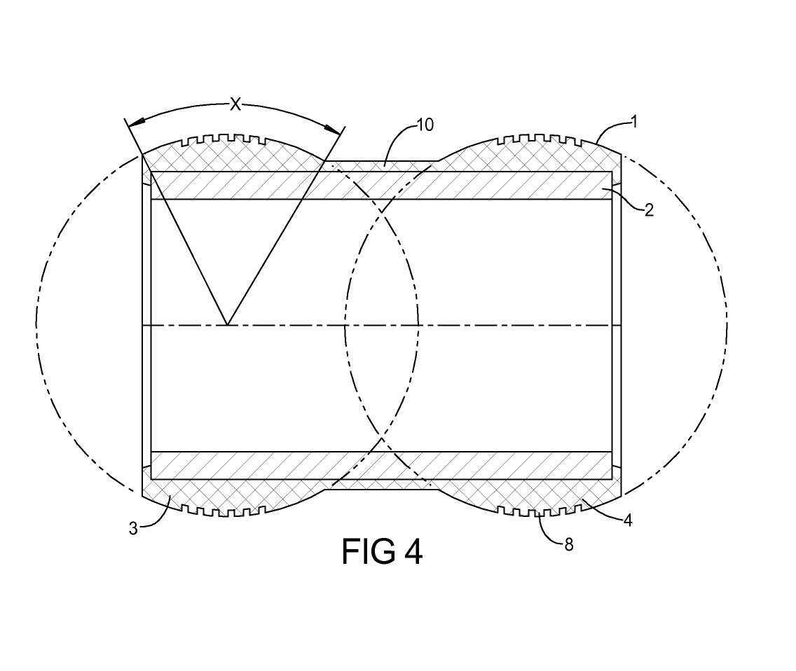

The exemplary embodiment shown in FIG. 4 corresponds to that of FIG. 3, but unlike the former, has a lamellar fluting 8.

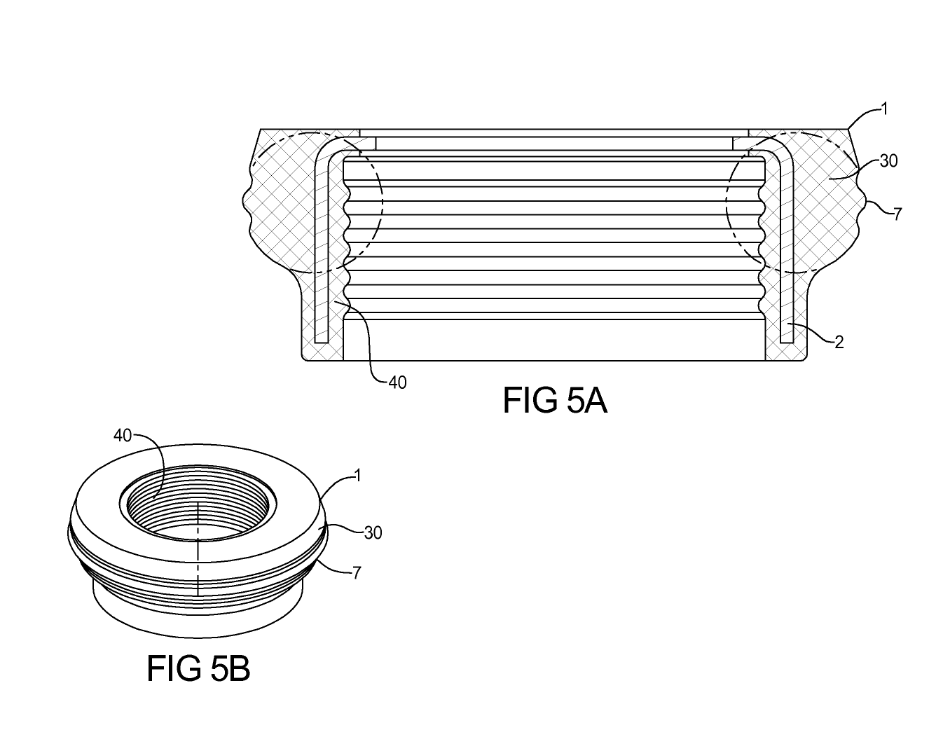

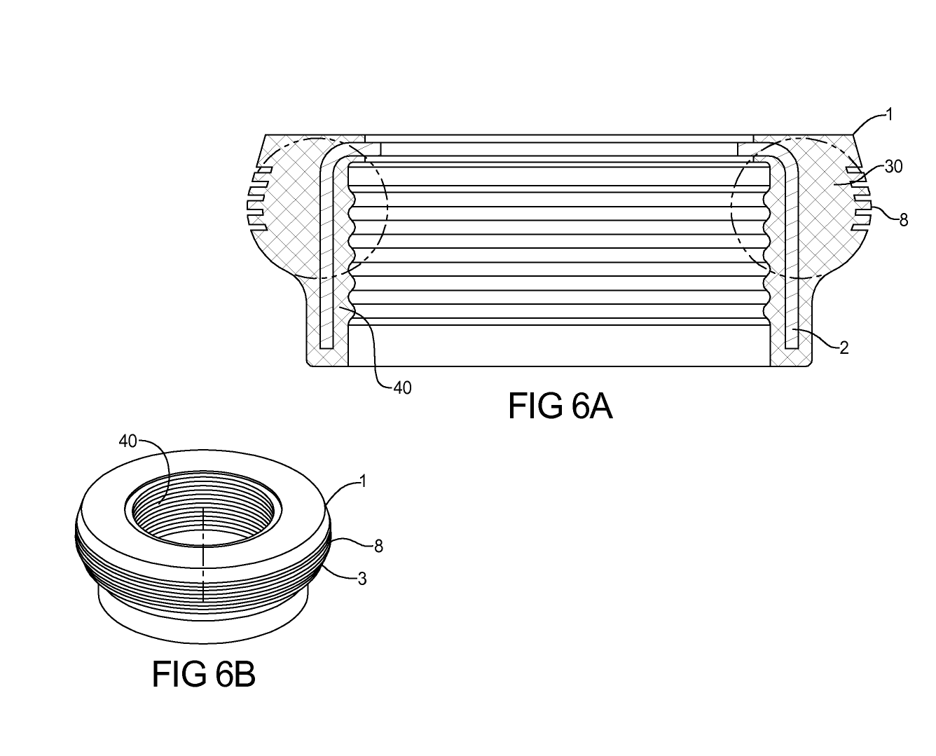

Each of the exemplary embodiments shown in FIGS. 5A-B through 8A-B have at one end face of the support body 2 an outer encircling sealing bead 30. The sealing bead 30 shown in each of the figures is designed as a sphere, wherein the curved sealing surface in FIGS. 5A-B and 7A-B has a wavy fluting 7 and a lamellar fluting 8 in FIGS. 6A-B and 8A-B. Provided at the other end face of the support body is an encircling radially inwardly pointing second sealing element 40. This end of the plug-in piece 1 is adapted for sealing with respect to the outside surface of a tubular-shaped hollow body that can be inserted in said end. Without limitation to generality, the first sealing element 30 and the second sealing element 40 lie in the same radial plane in the embodiments shown. The advantage of this is that the plug-in piece 1, as a connecting element, uses no additional installation space, since the cylindrical surfaces to be connected, that is the tubular shaped hollow bodies, can be slipped over each another. Thus, the exemplary embodiments described are suitable in particular for narrow installation spaces.

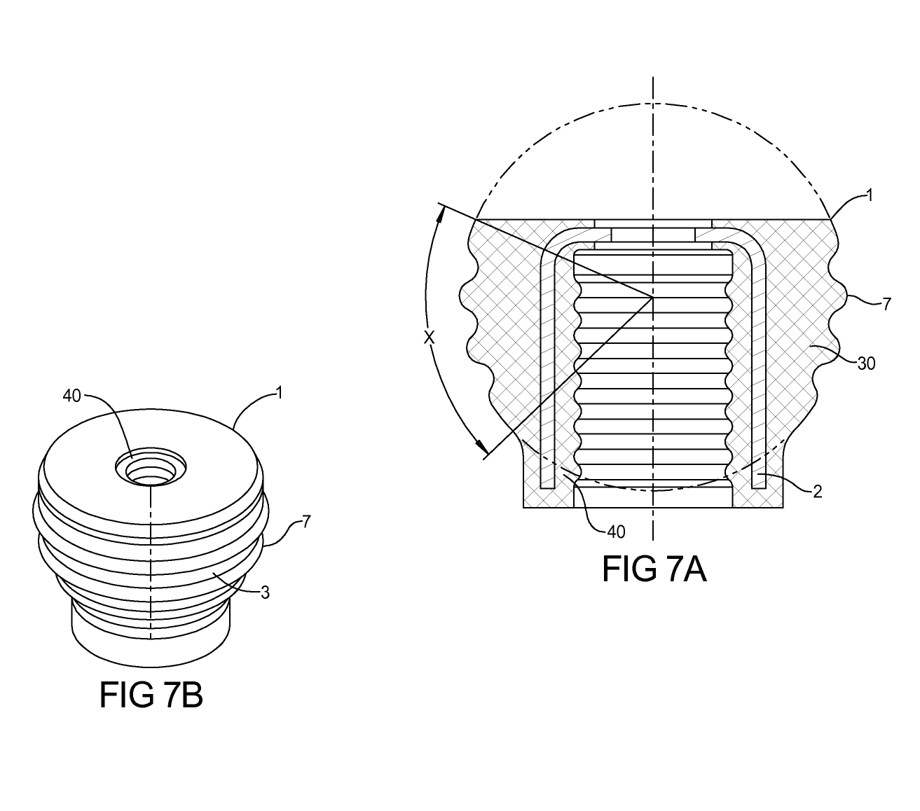

In the exemplary embodiments shown in FIGS. 7A-B and 8A-B, the center point of the sphere lies in approximately the symmetrical axis of the support body 2, analogous to the exemplary embodiments in FIGS. 3 and 4.

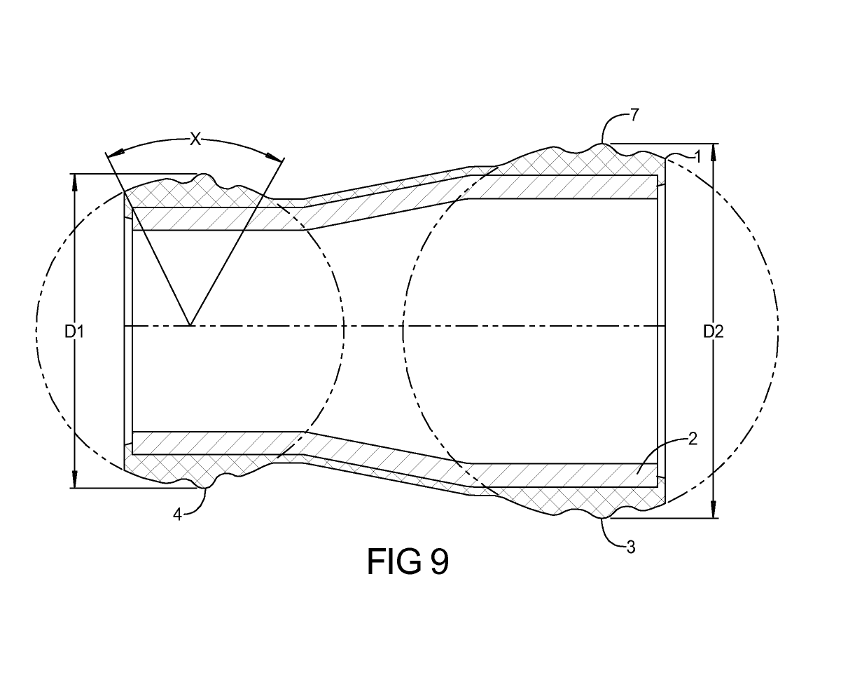

The exemplary embodiment of FIG. 9 is again designed in the shape of a dumb-bell with two encircling spherically-shaped sealing beads 3, 4 and with a wavy fluting at both end faces of the support body 2. It has not only a connecting, but also an adapter function, since the inside diameter of the support body 2 expands in conical fashion from the one end face to the other end face. This plug-in piece 1 is adapted for connecting cylindrical surfaces that have different inside diameters.

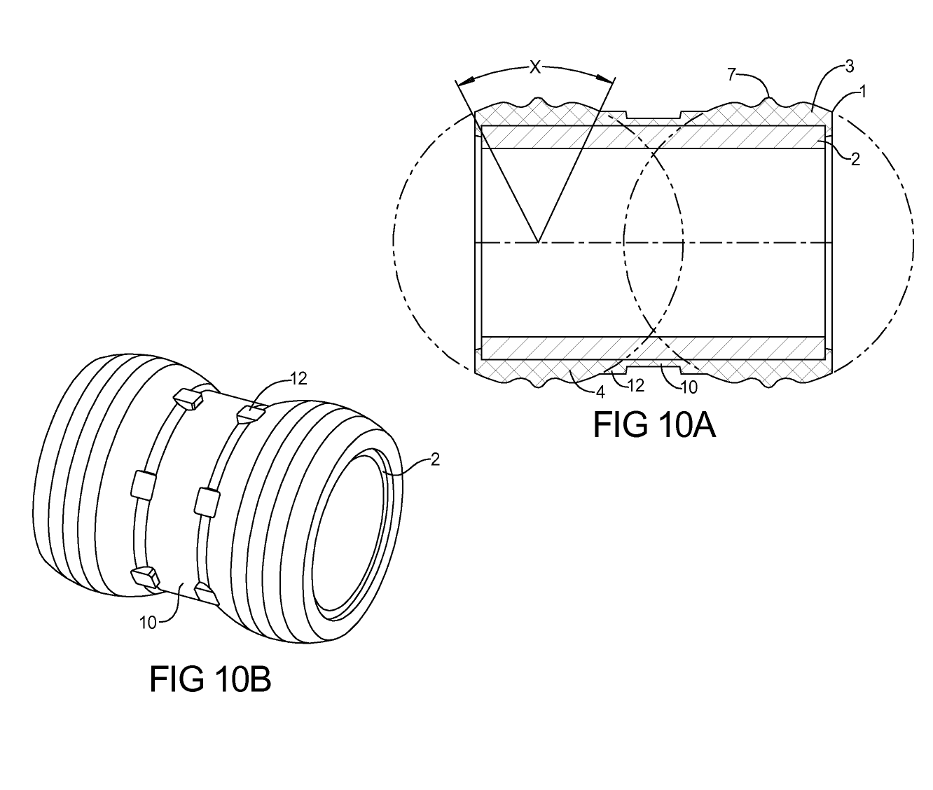

The plug-in piece 1 shown in FIGS. 10A and 10B corresponds to that shown in FIG. 3. However, it includes additional centering cams 12 distributed in annularly encircling regions on its outer circumference. These are tasked with abutting the cylindrical surface to be sealed in order to center the plug-in piece 1 during installation in the first installation space. This facilitates attachment in the second installation space. Centering cams 12 are therefore particularly helpful when multiple plug-in pieces 1 are to be installed simultaneously or during blind installation.

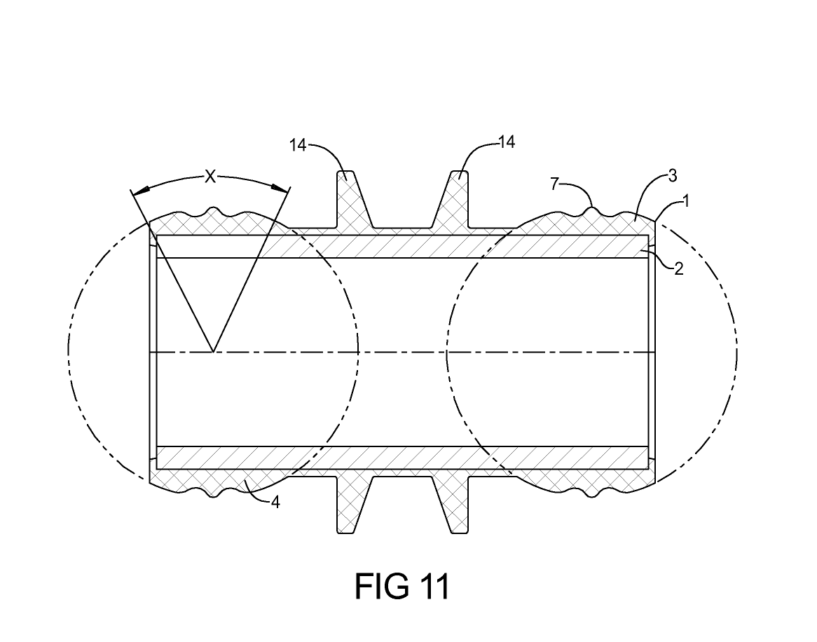

The exemplary embodiment of FIG. 11 also corresponds to that of FIG. 3. It has in addition dust lips 14. The dust lips 14 keep the sealing beads free of outside contaminants.

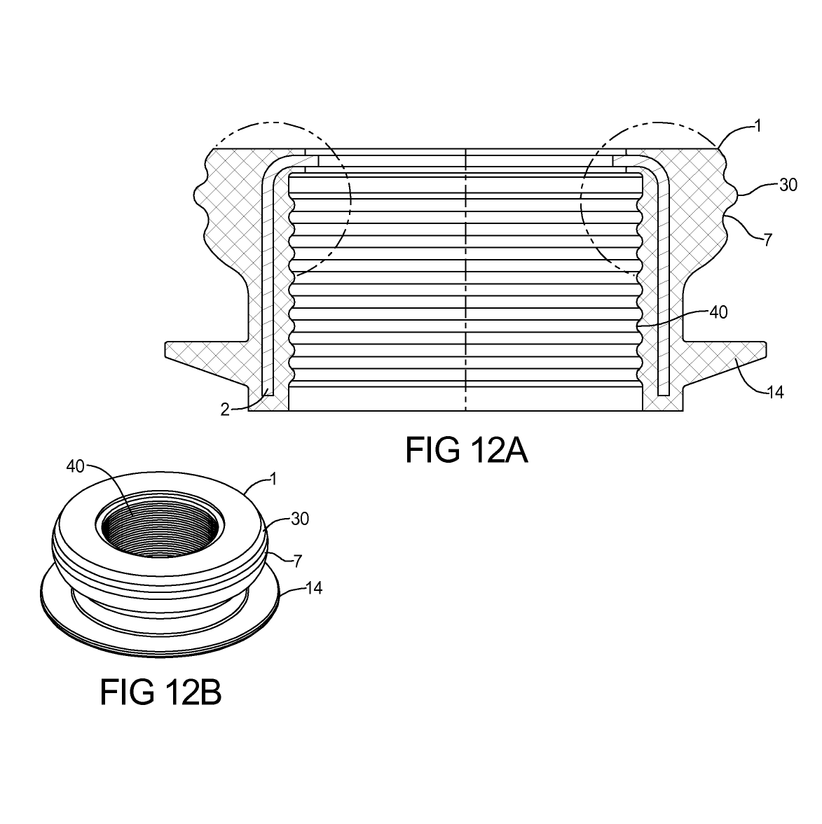

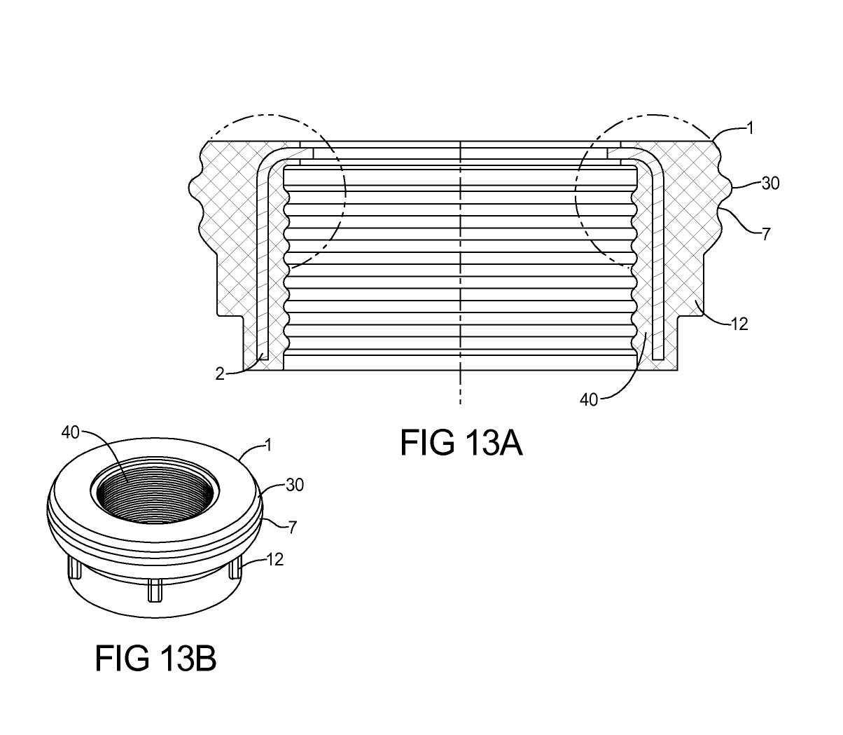

The exemplary embodiments of FIGS. 12A-B and 13A-B correspond to that shown in FIG. 5, but are also fitted with dust lips 14 (FIGS. 12A-B) and centering cams 12 (FIGS. 13A-B).

what is claimed is:

1. A plug-in piece (1) for the sealing connection of two mutually assigned cylindrical surfaces, comprising a support body (2) which is substantially in the shape of a hollow body and has at least one annularly encircling sealing element which can be brought into engagement with one of the cylindrical surfaces to be sealed in order to produce a tight connection, wherein the sealing element is designed as a sealing bead (3) which annularly encircles the outer surface of the support body and has a curved sealing surface, wherein the annularly encircling sealing bead (3, 30) has an encircling fluting following the contour thereof in the region of the curved sealing surface.

2. The plug-in piece according to claim 1, wherein the flutes are designed in such a manner that the bead has a wavy outer contour (7) in longitudinal section.

3. The plug-in piece according to claim 1, wherein the sealing bead (3, 30) is of spherical design in cross section.

4. The plug-in piece according to claim 3, wherein the radius of the sphere of the sealing bead (3, 30) is selected in such a manner that the center point of the sphere lies approximately on the axis of symmetry of the support body (2).

5. The plug-in piece according to claim 4, wherein the deviation of the center point of the sphere from the axis of symmetry is less than 10%.

6. The plug-in piece according to claim 1, wherein a further sealing bead (4) encircling the outer circumference of the support body (2) is provided at the second end of the support body (2).

7. The plug-in piece according to claim 6, wherein it is in the shape of a dumb-bell, wherein the first sealing bead (3) and the second sealing bead (4) are of mirror-inverted design with respect to each other at the two ends.

8. The plug-in piece according to claim 6, wherein the inside diameter of the support body (2) expands from one end towards the other end.

9. The plug-in piece according to claim 1, wherein a further, radially inwardly pointing, second sealing element (40) is provided at the second end of the support body (2).

10. The plug-in piece according to claim 9, wherein the first sealing bead (30) and the inwardly pointing, second sealing element (40) lie in the same axial plane.

11. The plug-in piece according to claim 1, wherein the outer circumference and/or inner circumference of the support body (2) is at least partially provided with a casing (10).

12. The plug-in piece according to claim 11, wherein the sealing elements (3, 4, 30, 40) and the casing (10) are formed as a single piece and from the same material.
